(19) United States
(12) Patent Application Publication
(10) Pub. No.: US 2004/0200332 A1
(43) Pub. Date: Oct. 14, 2004

(54) Cable receiving or storing device

(76) Inventor: Hsi Tang Chen, Taichung (TW)

Correspondence Address: Hsi Tang Chen, P.O. Box 63-99, Taichung, 406, TW

(21) Appl. No.: 10/412,775

(22) Filed: Apr. 9, 2003

(51) Int. Cl. B26D 7/06

(52) U.S. Cl. 83/648; 83/649

(57) ABSTRACT

A cable receiving device includes a spool member rotatably engaged onto a hub of a plate for receive wires. A clamping member may be engaged onto the spool member and engaged onto the wires, to position the wires in the spool member. A cutter device has a base secured onto the plate and a cutter blade extended from the base, for cutting the wires. The clamping member includes an opening formed by two end beads for engaging with the wires. The plate includes a stop for limiting the clamping member to rotate relative to the plate.

### BACKGROUND OF THE INVENTION

1. Field of the Invention

The present invention relates to a cable receiving device, and more particularly to a cable receiving or storing device for storing wires or cables and for allowing the wires or cables to be retracted into the cable receiving device.

2. Description of the Prior Art

Various kinds of typical cable receiving devices have been developed and comprise a spool member for receiving or storing wires or cables thereon. The wires or cables may be pulled out of the spool member for further use.

Normally, after the wires or cables have been pulled out of the spool member, it will be difficult to retract the wires or cables into the spool member again, such that the surplus wires or cables that have been pulled out of the spool member should be cut off and discarded.

In addition, the typical cable receiving devices have no suitable cutting members for cutting off the wires or cables such that additional tools or cutters are required to be prepared by the users in order to cut off the wires or cables.

The present invention has arisen to mitigate and/or obviate the afore-described disadvantages of the conventional cable receiving devices.

### SUMMARY OF THE INVENTION

The primary objective of the present invention is to provide a cable receiving device having a retracting device for retracting the wires or cables into the cable receiving device.

The other objective of the present invention is to provide a cable receiving device having a cutting device for easily and readily cutting the wires or cables off the cable receiving device.

In accordance with one aspect of the invention, there is provided a cable receiving device comprising a plate including a hub extended therefrom, a spool member including a bore formed therein to rotatably receive the hub of the plate, and thus to rotatably attach the spool member onto the hub of the plate, and to receive wires thereon, and a clamping member engaged onto the spool member, and including two sides for engaging onto the wires, and for retaining and positioning the wires in the spool member, and thus for preventing the wires from becoming loose relative to the spool member.

The clamping member includes an opening formed therein and defined by two ends for engaging the clamping member onto the spool member. Each of the ends of the clamping member includes a bead formed therein for smoothly engaging with the wires, and for allowing the wires to be easily pulled out of the spool member.

The plate includes a stop secured thereto, and engageable with either of the ends of the clamping member, to limit a rotational movement of the clamping member relative to the plate. The plate includes a peripheral wall provided therein and having a notch formed therein to partially receive the stop. The plate includes a depression formed therein and defined by the peripheral wall to partially receive the spool member.

A cover may further be provided and attached onto the spool member and rotated in concert with the spool member. The spool member includes at least one orifice formed therein, the cover includes at least one projection extended therefrom and engaged into the orifice of the spool member, to secure the cover to the spool member. The wire may be received or retracted into the spool member by rotating the spool member with the cover.

The cover includes a casing extended therefrom and engaged into the bore of the spool member and engaged with the hub of the plate, and secured to the hub of the plate with such as a fastener or the like. The cover may further include a peripheral skirt extended therefrom and partially engaged onto the spool member to partially cover or shield the spool member and the wires.

A cutter device may further be provided and includes a base secured onto the plate, and includes a cutter blade extended from the base to form a cutter slit between the base and the cutter blade. The wires may be forced through the cutter slit that is formed or defined between the base and the cutter blade, for allowing the wire to be cut by the cutter blade.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is an exploded view of a cable receiving device in accordance with the present invention;

FIG. 2 is a perspective view of the cable receiving device;

FIG. 3 is a cross sectional view of the cable receiving device, taken along lines 3-3 of FIG. 2;

FIG. 4 is a front plan view illustrating the operation of the cable receiving device; and

FIG. 5 is a side plan view illustrating the operation of the cable receiving device.

### DETAILED DESCRIPTION OF THE PREFERRED EMBODIMENT

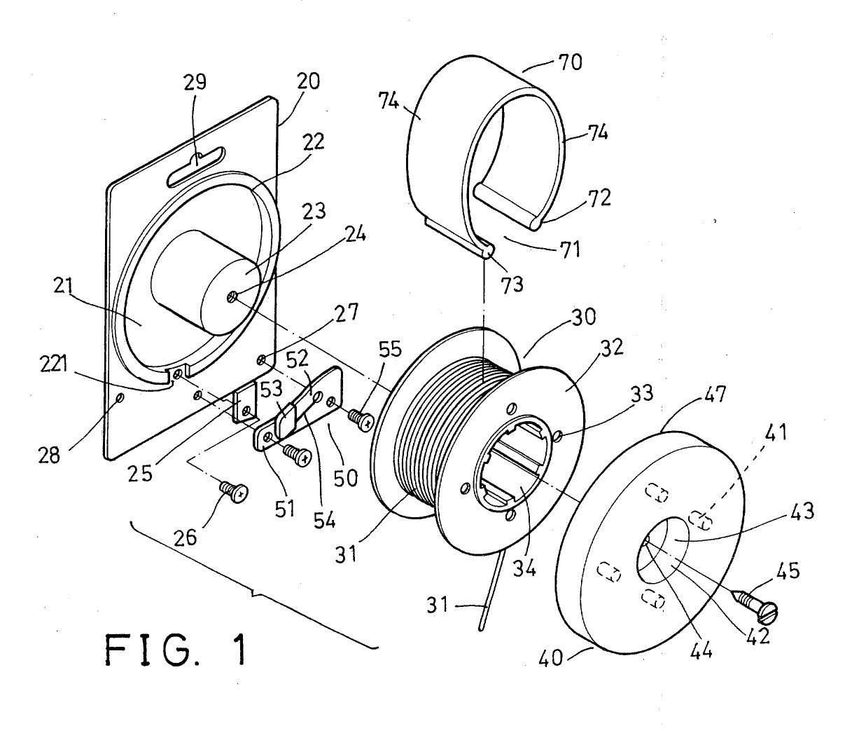

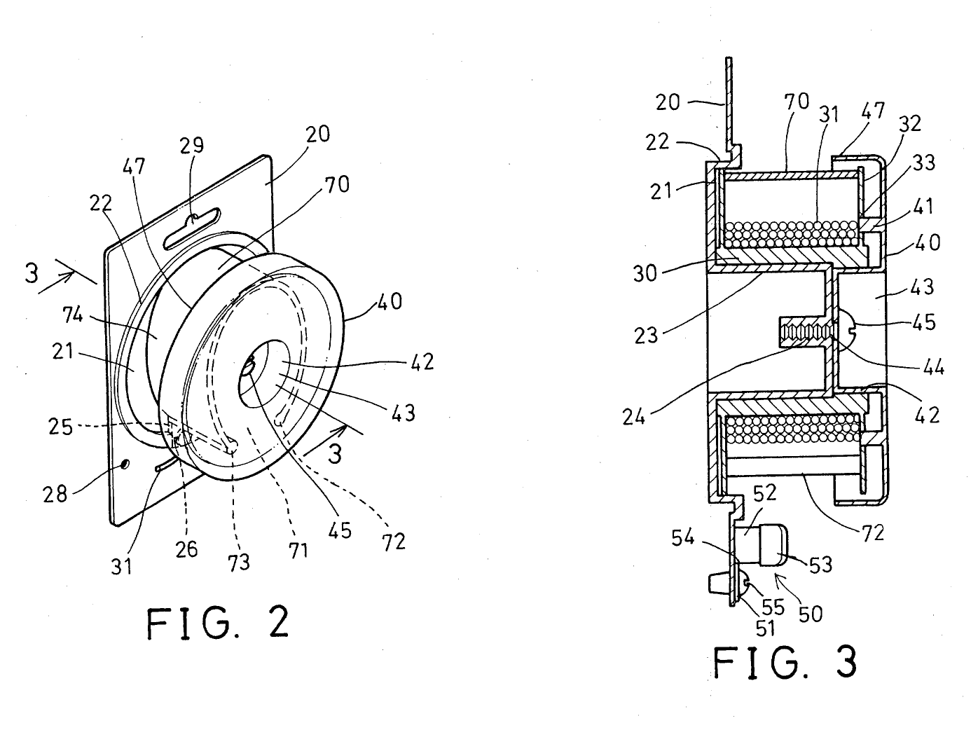

Referring to the drawings, and initially to FIGS. 1-4, a cable receiving device in accordance with the present invention comprises a plate 20 including a depression 21 formed therein and defined by a peripheral wall 22 which may include a notch 221 formed therein, and including a hub 23 extended from the middle or center portion thereof and having a screw hole 24 formed therein.

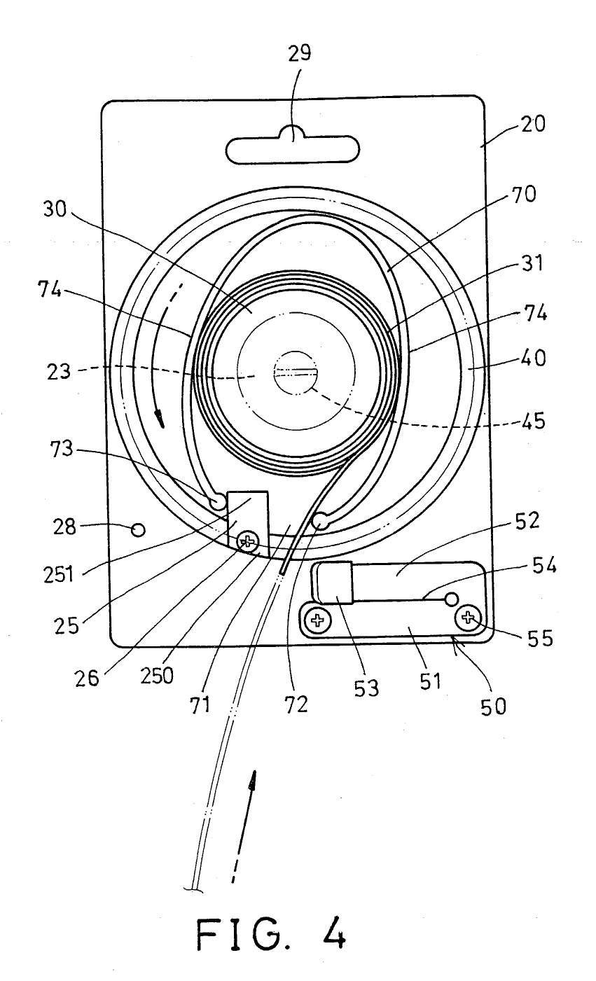

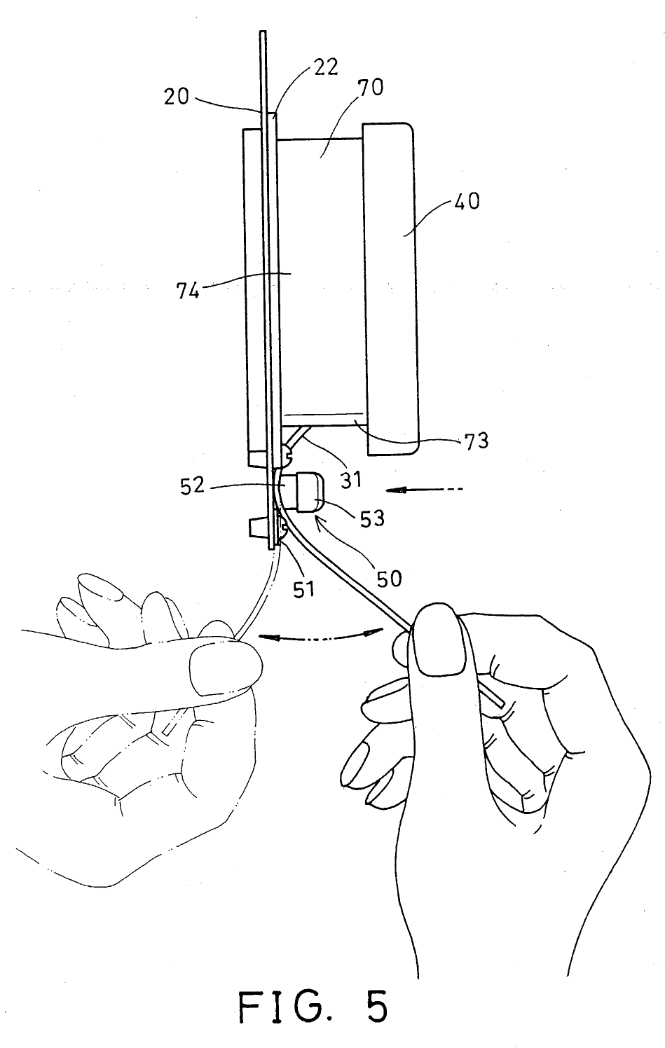

A stop 25 has one end 250 received in the notch 221 of the peripheral wall 22, and secured to the peripheral wall 22 or the plate 20 with a fastener 26, and has the other end 251 extended into the depression 21 of the plate 20 (FIG. 4).

A pulley or spool member 30 is rotatably engaged onto the hub 23 of the plate 20 for winding or supporting or storing one or more wires or cables 31 thereon. The spool member 30 includes one side panel 32 having one or more orifices 33 formed therein. The spool member 30 includes a bore 34 formed therein to rotatably receive the hub 23 of the plate 20.

A cover 40 is engaged onto or disposed beside the panel 32 of the spool member 30, and includes one or more projections 41 extended therefrom for engaging into the orifices 33 of the spool member 30, and for securing the cover 40 to the spool member 30, and thus for allowing the cover 40 and the spool member 30 to be rotated in concert with each other.

The cover 40 includes a casing 42 extended therefrom and engaged into the bore 34 of the spool member 30, and engaged onto the hub 23 of the plate 20. The casing 42 includes a chamber 43 formed therein, and an aperture 44 formed therein and communicating with the chamber 43 thereof to receive a fastener 45 which may secure the casing 42 of the cover 40 to the hub 23 of the plate 20, in order to rotatably secure the cover 40 and the spool member 30 to the plate 20.

In operation, the spool member 30 and/or the cover 40 may be rotated by the users, such that the wires or cables 31 may be pulled out of the spool member 30. Or, the spool member 30 and/or the cover 40 may be rotated relative to the plate 20 while pulling the wires or cables 31 out of the spool member 30, such that the wires or cables 31 may be easily pulled out of the spool member 30.

As best shown in FIG. 3, the cover 40 includes a peripheral skirt 47 extended from the outer peripheral portion thereof, and partially extended into the spool member 30, for partially covering or shielding the outer portion of the spool member 30 and the wires or cables 31. The spool member 30 has an inner portion received in the depression 21 of the plate 20 such that the spool member 30 and the wires or cables 31 may also be partially covered or shielded by the peripheral wall 22 of the plate 20.

A clamping member 70 includes an opening 71 formed therein and defined by two end beads 72, 73, for allowing the clamping member 70 to be engaged onto the spool member 30, and the clamping member 70 includes two sides 74 for engaging onto the wires or cables 31 (FIG. 4), and for retaining the wires or cables 31 in the spool member 30. The wires or cables 31 may be pulled out of the spool member 30 via the opening 71 of the clamping member 70.

As also shown in FIG. 4, the end beads 72, 73 of the clamping member 70 may be engaged with the stop 25 which may thus be used to limit the rotational movement of the clamping member 70 relative to the stop 25 and the plate 20. The end beads 72, 73 of the clamping member 70 may be engaged with the wires or cables 31 (FIG. 4), for allowing the wires or cables 31 to be pulled out of the spool member 30 via the opening 71 of the clamping member 70.

The plate 20 further includes one or more holes 27 formed therein. A cutter device 50 includes a base 51 secured to the plate 20 with such as fasteners 55 which may be engaged into or threaded to the holes 27 of the plate 20. The cutter device 50 includes a cutter blade 52 extended from the base 51, to form a cutter slit 54 between the cutter blade 52 and the base 51 and a knob 53 attached to the free end of the cutter blade 52.

In operation, the users may pull the wires or cables 31 out of the spool member 30, and may then force the wires or cables 31 through the cutter slit 54 that is formed between the cutter blade 52 and the base 51, for allowing the wires or cables 31 to be easily cut by the cutter device 50. When excessive or surplus wires or cables 31 have been pulled out of the spool member 30, the wires or cables 31 may be retracted into the spool member 30 again by rotating the spool member 30 with the cover 40.

The plate 20 may further include an aperture 28 formed therein to receive the end portion of the wires or cables 31, and to retain or position the end portion of the wires or cables 31 in or relative to the plate 20. The plate 20 may include an opening 29 formed therein for hanging and/or displaying purposes.

Accordingly, the cable receiving device in accordance with the present invention includes a retracting device for retracting the wires or cables into the cable receiving device, and includes a cutting device for easily and readily cutting the wires or cables off the cable receiving device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cable receiving device comprising:
a plate including a hub extended therefrom,
a spool member including a bore formed therein to rotatably receive said hub of said plate, and thus to rotatably attach said spool member onto said hub of said plate, and to receive wires thereon, and
a clamping member engaged onto said spool member, and including two sides for engaging onto the wires, and for retaining the wires in said spool member.

2. The cable receiving device as claimed in claim 1, wherein said clamping member includes an opening formed therein and defined by two ends for engaging said clamping member onto said spool member.

3. The cable receiving device as claimed in claim 2, wherein each of said ends of said clamping member includes a bead formed therein for engaging with the wires.

4. The cable receiving device as claimed in claim 2, wherein said plate includes a stop secured thereto, and engageable with either of said ends of said clamping member, to limit a rotational movement of said clamping member relative to said plate.

5. The cable receiving device as claimed in claim 4, wherein said plate includes a peripheral wall provided therein and having a notch formed therein to partially receive said stop.

6. The cable receiving device as claimed in claim 5, wherein said plate includes a depression formed therein and defined by said peripheral wall to partially receive said spool member.

7. The cable receiving device as claimed in claim 1 further comprising a cover attached onto said spool member and rotated in concert with said spool member.

8. The cable receiving device as claimed in claim 7, wherein said spool member includes at least one orifice formed therein, said cover includes at least one projection extended therefrom and engaged into said at least one orifice of said spool member, to secure said cover to said spool member.

9. The cable receiving device as claimed in claim 7, wherein said cover includes a casing extended therefrom and engaged into said bore of said spool member and engaged with said hub of said plate.

10. The cable receiving device as claimed in claim 1 further comprising a cutter device including a base secured onto said plate, and including a cutter blade extended from said base,
